(19) United States
(12) Patent Application Publication
(10) Pub. No.: US 2014/0001287 A1
(43) Pub. Date: Jan. 2, 2014

(54) DUAL FLOW PATH DRIP IRRIGATION APPARATUS AND METHODS

(71) Applicant: Rick Mavrakis, Alta Loma, CA (US)

(72) Inventor: Rick Mavrakis, Alta Loma, CA (US)

(21) Appl. No.: 13/812,808

(22) PCT Filed: Jul. 21, 2011
(86) PCT No.: PCT/US11/44779

§ 371 Date: Sep. 12, 2013

Related U.S. Application Data
(60) Provisional application No. 61/369,626, filed on Jul. 30, 2010.

(51) Int. Cl. A01G 25/02

(52) U.S. Cl. CPC A01G 25/023
USPC 239/453

(57) ABSTRACT

Drip tubing is provided that has a first flow path and a second, independent flow path. A plurality of first drip irrigation devices are associated with the first flow path for dispensing fluid from the first flow path at a first precipitation rate. A plurality of second drip irrigation devices are associated with the second flow path for dispensing fluid from the second flow path at a second precipitation rate. The first and second drip irrigation devices are preferably different, and the first and second precipitation rates are also preferably different. One of the drip irrigation devices may be a drip emitter discharging drips of fluid and the other may be discharge fluid in a spray pattern.

### CROSS REFERENCE TO RELATED APPLICATION

This patent application claims the benefit of U.S. Provisional Application No. 61/369,626, filed Jul. 30, 2010, the content of which is incorporated herein by reference in its entirety.

### FIELD

This description relates to drip irrigation apparatus and methods and, in particular, drip irrigation apparatus and methods for delivering different types of irrigation.

### BACKGROUND

Drip irrigation devices can be useful for providing a low precipitation rate of fluid for irrigation purposes, such as drips of water. Drip irrigation devices are frequently associated with tubing, such that a tube will have a plurality of spaced drip irrigation devices. When the tube is positioned in an area for irrigation and pressurized with water or other fluid, the fluid exits the tubing in a plurality of discrete locations to irrigate the area.

Different stages of plant growth can require different precipitation rates. One solution is to use a first set of irrigation devices being used for irrigating during a one stage of plant growth. That first set can then either be left in place or remove, and a second set of irrigation devices being used for irrigating during a second stage of plant growth. One or both of the first sets of irrigation devices may be drip irrigation devices. However, the time, labor and equipment often required to set up two different sets of irrigation devices can be disadvantageous.

### SUMMARY

Drip tubing is provided that has a first flow path and a second, independent flow path. A plurality of first drip irrigation devices are associated with the first flow path for dispensing fluid from the first flow path at a first precipitation rate. A plurality of second drip irrigation devices are associated with the second flow path for dispensing fluid from the second flow path at a second precipitation rate. The first and second drip irrigation devices are preferably different, and the first and second precipitation rates are also preferably different. Advantageously, the same drip tubing can be used to provide a first precipitation rate during a first stage of plant growth as well as a second precipitation rate during a second stage of plant growth.

### BRIEF DESCRIPTION OF THE DRAWINGS

FIG. 1 is a perspective view of a first embodiment of an extensible drip irrigation device, showing a deflector in an extended position relative to a base but not extending above the base;

FIG. 2 is a side elevation view of the extensible drip irrigation device of FIG. 1;

FIG. 3 is a front elevation view of the extensible drip irrigation device of FIG. 1;

FIG. 4 is a section view of the extensible drip irrigation device of FIG. 1 taken along line IV-IV of FIG. 2;

FIG. 5A is an exemplary portion of a length of dual drip tubing, with one of the tubes having a drip emitter and the other, independent tube having the extensible drip irrigation device of FIG. 1;

FIG. 5B is a left side elevation view of the length of dual drip tubing of FIG. 5A;

FIG. 6 is a section view of the dual drip tubing of FIG. 5, taken along line VI-VI thereof and showing the drip emitter in one of the tubes and the extensible drip irrigation device in the other of the tubes;

FIG. 7 is a perspective view of a second embodiment of an extensible drip irrigation device, showing a deflector in an extended position relative to a base and extending above the base;

FIG. 8 is a side elevation view of the extensible drip irrigation device of FIG. 7;

FIG. 9 is a front elevation view of the extensible drip irrigation device of FIG. 7;

FIG. 10 is a section view of the extensible drip irrigation device of FIG. 7 taken along line X-X of FIG. 8;

FIG. 11A is an exemplary portion of a length of dual drip tubing, with one of the tubes having a drip emitter and the other, independent tube having the extensible drip irrigation device of FIG. 7;

FIG. 11B is a left side elevation view of the length of dual drip tubing of FIG. 11A;

FIG. 12 is a section view of the dual drip tubing of FIG. 11, taken along line XII-XII thereof and showing the drip emitter in one of the tubes and the extensible drip irrigation device in the other of the tubes;

FIG. 13 is a front elevation view of the extensible drip irrigation device of FIG. 7, but showing the deflector in a retracted position;

FIG. 14 is a side elevation view of the extensible drip irrigation device of FIG. 7, but showing the deflector in the retracted position; and

FIG. 15 is a section view of the extensible drip irrigation device of FIG. 7, but showing the deflector in the retracted position and taken along line XV-XV of FIG. 14.

### DETAILED DESCRIPTION

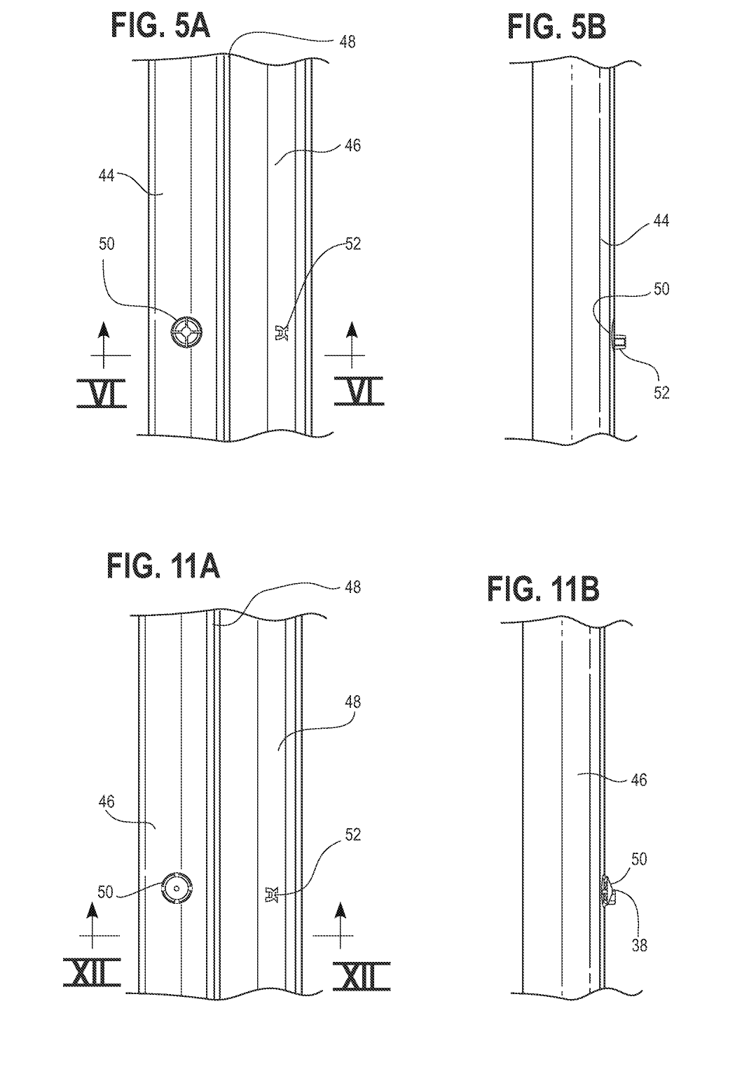

Dual drip tubing is provided that has a first tube 44 defining a first flow path and a second tube 46 defining a second, independent flow path, as illustrated in FIGS. 5A and 11A. A first type of drip irrigation device is associated with the first tube 44 and a second, preferably though not necessarily different, type of drip irrigation device 8 is associated with the second tube 46, as illustrated in FIGS. 6 and 12. The first and second tubes are joined together, such as by a bridge 48, which may be continuous or discontinuous, along the length of the tubing. The bridge 48 can be joined between adjacent wall portions of the tubes, or between tangential segments. Although only a single segment of dual drip tubing is depicted in FIGS. 5A, 5B, 11A and 11B, it will be understood that such a pattern could be repeated over various lengths.

When the first and second drip irrigation devices and 8 are different, the same dual drip tubing can advantageously be used to provide different precipitation rates and/or different types of irrigation. This can eliminate many of the disadvantages associated with having two separate sets of irrigation devices with separate, unassociated flow paths, including having to place and then remove the first set before placing the second set. Yet another advantage is that the different tubes 44 and 46 can be used to deliver different fluids relatively contemporaneously. For example, the first tube 44 can be delivered nutrient-enriched water and then a short time later or during the next irrigation cycle the second tube can deliver unenriched water. The drip irrigation devices 8 and 10 can be arranged in a staggered relationship, or can be aligned.

One of the drip irrigation devices can be an emitter 8. The emitter 8 is attached to the interior of the second tube 46, as illustrated in FIG. 6, and have an inlet in fluid communication with the flow path extending through the second tube 46 and an outlet in fluid communication with an opening formed through the wall of the tube 46. A tortuous path or other fluid pressure reduction structure is disposed between the inlet and the outlet of the emitter for discharging fluid in drip manner. Suitable emitters 8 are disclosed, for example, in U.S. Pat. Publ. Nos. US 2007/0194149 and US 2006/0237561, which are hereby incorporated by reference in their entireties. The drip emitters 8 may be suitable for irrigating a plant during a later stage of growth following germination, where a lower precipitation rate is desired.

One of the drip irrigation devices can be an extensible drip irrigation device 10 configured to discharge fluid in a spray pattern, such as a close-in spray pattern (e.g., a radius of between about 1 and about feet from the device). The spray pattern may be circular, i.e., 360 degrees about the device, a half-circle of about 180 degrees, a quarter circle of about 90 degrees, or other arcuate extents. The extensible drip irrigation devices 10 may be suitable for irrigating a plant during an early stage of growth, such as germination, where a higher precipitation rate and/or a larger area of irrigation is desired.

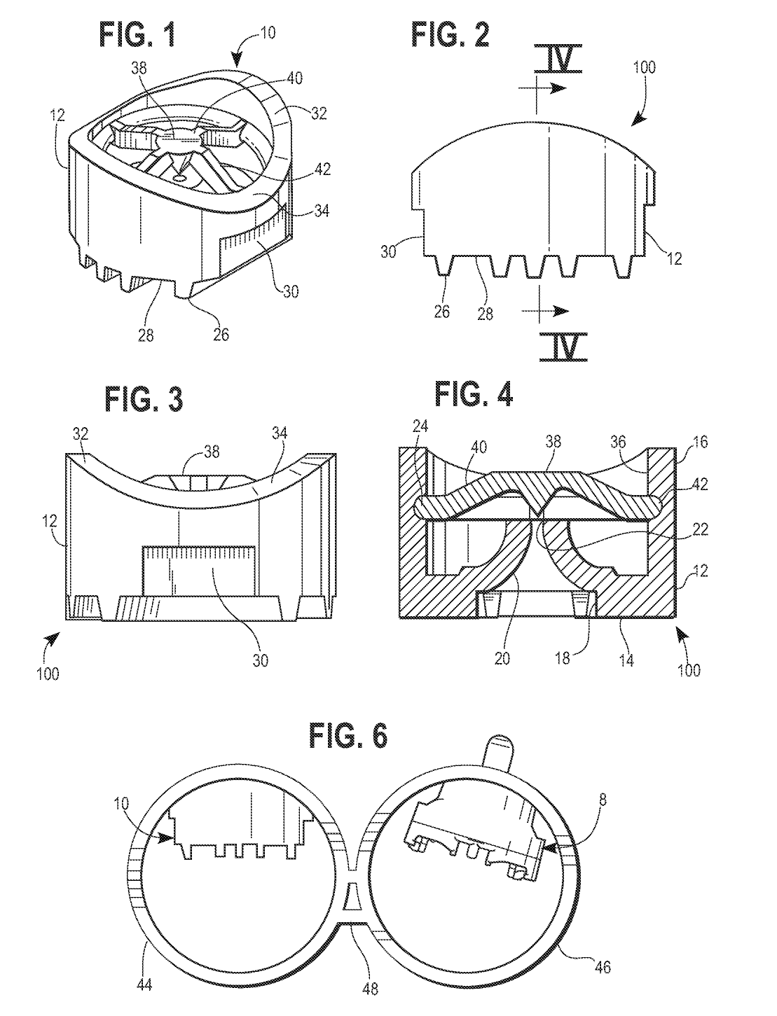

Turning to the details of a first exemplary embodiment of the extensible drip irrigation device 10, illustrated in FIGS. 1-6, a generally cylindrical housing is provided having a bottom wall 14 and an upstanding sidewall 16 disposed about the periphery of the bottom wall 14 surrounding an opening 36 opposite the bottom wall 14, as illustrated in FIG. 4. The bottom wall 14 includes an inlet opening 18 and an outlet opening 22, with a nozzle 20 positioned therebetween.

A deflector 38 is disposed within the confines of the sidewall 16 of the housing 12. The inlet opening 18 of the housing 12 receives fluid from the first flow path defined by the first tube 44 and discharges it through the outlet opening 22 and against a central portion 40 of the deflector 38. The deflector 38 then deflects the discharging fluid through openings defined between radially-extending legs 42 of the deflector 38 and adjacent inner surfaces of the sidewall 16 of the housing 12 in a spray pattern. When attached to the inner surface of the first tube 44, the extensible drip irrigation device 10 is aligned with an opening 50 extending through the wall of the tube 44 so that the spray pattern can exit the tube 44 and irrigate the adjacent terrain. Preferably, though not necessarily, the deflector 38 is recessed within the tube 44 in its second position, i.e., it does not protrude into and/or past the opening 50 in the tube 44.

The deflector 38 is optionally extensible from a first position to a second position, whereby the second position is further away from the outlet opening 22. When manufactured, the deflector 38 can be in its first position. Upon pressurization with fluid, the deflector 38 can move from its first position to its second position. The deflector 38 can be limited from extending past its second position by engagement between radially outward end portions of the legs 42 and a circumferential groove 24 extending about the inner surface of the sidewall 16 of the housing 12, as illustrated in FIG. 4. The engagement of the legs 42 and groove 24 can also limit movement of the deflector 38 from the second position back to the first position when no longer pressurized with fluid.

To facilitate attachment to the curved, inner surface of the first tube 44, such as by welding or adhesive, the upwardly facing edge of the sidewall 16 can have a pair of raised portions 32 spacing a pair of depressed portions 34, as illustrate din FIGS. 1 and 3, thereby closely matching the curvature of the interior of the first tube 44 such that, when attached, a chamber is formed between the housing 12 and the first tube 44.

The first and second tubes 44 and 46 are preferably manufactured by coextrusion, although other manufacturing processes can be equally suitable. During extrusion, the first and second drip irrigation devices 10 and 8 can be sequentially inserted into their respective tubes 44 and 46 and attached to the inner walls thereof. The bridge 48 between the first and second tubes 44 and 46 can also be coextruded, such that the first and second tubes 44 and 46 have axially aligned first and second flow paths. To facilitate insertion and attachment of the extensible drip irrigation device 10, the underside of the bottom wall 14 of the housing 12 can include a series of ribs 26 separating channels 28 for use in guiding the devices 10 during manufacture. Similarly, a flat 30 can be formed on one or opposing sides of the housing 12 for providing a guide surface during manufacturing.

An advantage of using the dual drip tube is that the parallel drip tubes 44 and 46 can provide further support for maintaining preferred positioning of the opening 50 and thus the discharged spray pattern. If the two tubes 44 and 46 were not joined and there was just the single tube, then the openings could face in different directions when installed. Having the supporting second tube 46 can facilitate maintaining the openings 50 in their preferred orientations. For example, having open opening facing laterally and a downstream opening facing upwardly can disadvantageously result from twisting of a single tube during installation. The second tube 46 can advantageously resist the twisting of the first tube 44.

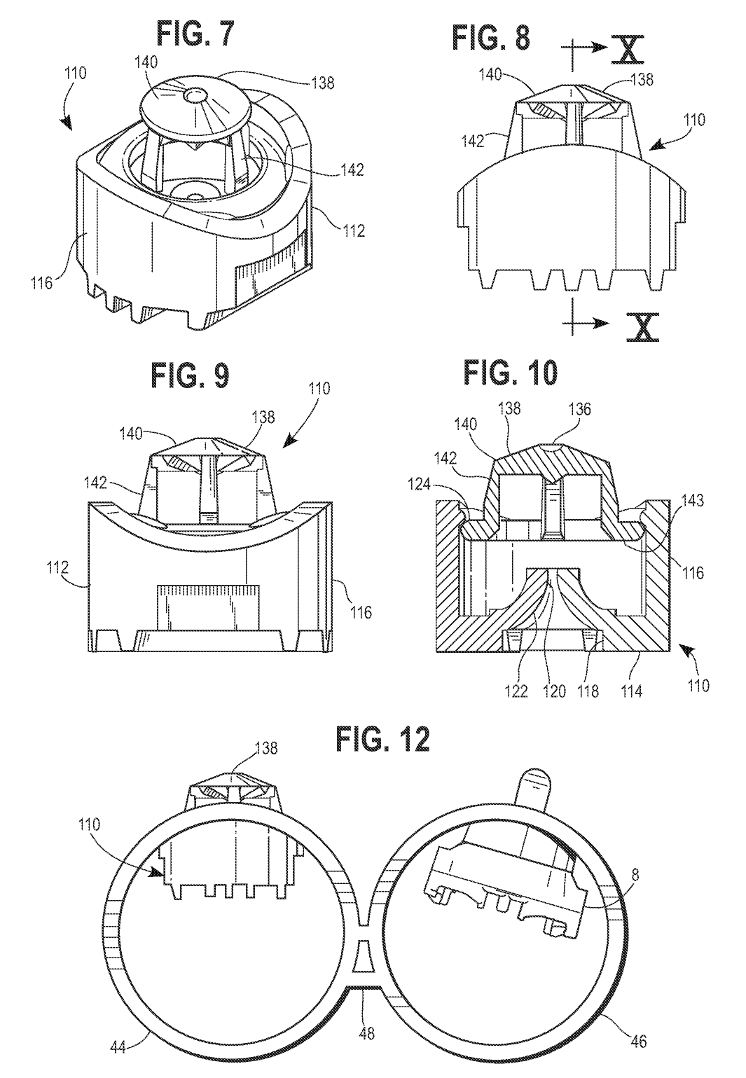

A second exemplary embodiment of an extensible drip irrigation device 110, illustrated in FIGS. 7-15, is dimensioned to partially protrude past the opening of its associated first tube 144, as depicted in FIGS. 11A, 11B and 12. More specifically, the deflector 138 partially protrudes through an opening 150 in the first tube 144, preferably only when pressurized.

The cylindrical housing 112 of the second exemplary embodiment of an extensible drip irrigation device 110 is similar to the housing 12 of the first exemplary embodiment, discussed above. That is, the housing 112 has a bottom wall 114 and an upstanding sidewall 116 disposed about the periphery of the bottom wall 114 surrounding an opening 136 opposite the bottom wall 114, as illustrated in FIGS. 10 and 15. The bottom wall 114 includes an inlet opening 118 and an outlet opening 120, with a nozzle 122 positioned therebetween.

A deflector 138 is disposed within the confines of the sidewall 116 of the housing 112. The inlet opening 118 of the housing 112 receives fluid from the first flow path defined by the first tube 144 and discharges it through the outlet opening 120 and against a central portion 140 of the deflector 138. The deflector 138 then deflects the discharging fluid through openings defined between downwardly-depending legs 142 of the deflector 138 and adjacent inner surfaces of the sidewall 116 of the housing 112 in a spray pattern. When attached to the inner surface of the first tube 144, the extensible drip irrigation device 110 is aligned with an opening 150 extending through the wall of the tube 144 so that the spray pattern can exit the tube 144 and irrigate the adjacent terrain.

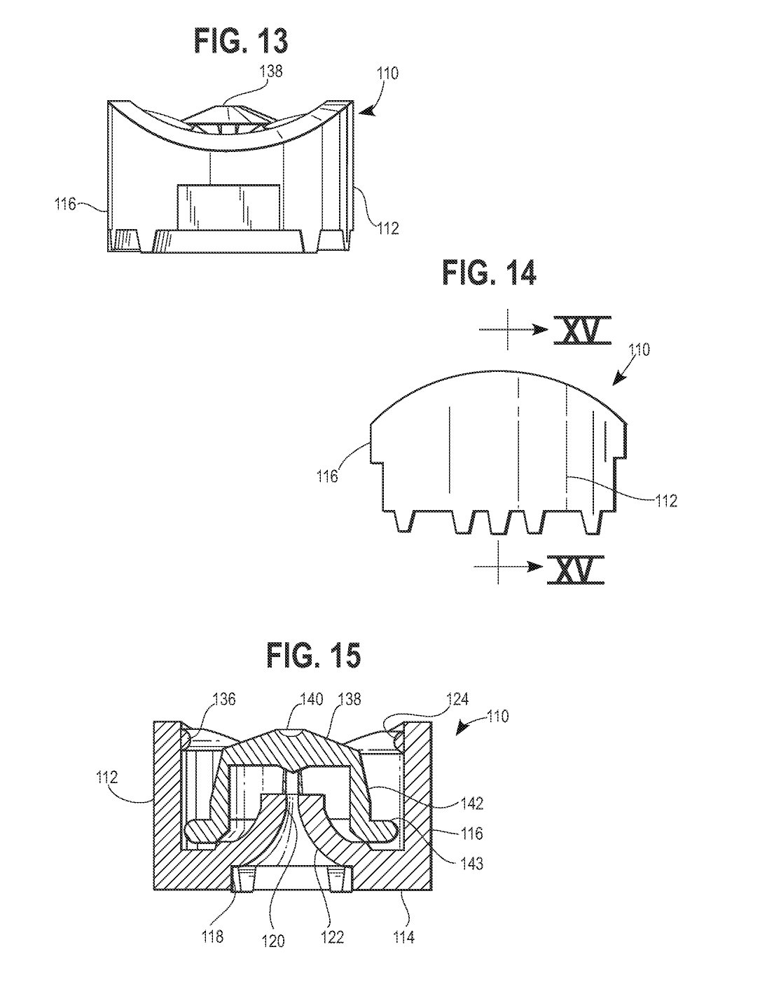

The deflector 138 is extensible from a first position, illustrated in FIGS. 13-15, to a second position, illustrated in FIGS. 7-12 whereby the second position is further away from the outlet opening 122. When manufactured, the deflector 138 can be in its first position. Upon pressurization with fluid, the deflector 138 can move from its first position to its second position. The deflector 138 can be limited from extending past its second position by engagement between radially-outward extending feet 143 of the legs 142 and an inwardly extending, circumferential protuberance 124 extending about the inner surface of the sidewall 116 of the housing 112, as illustrated in FIG. 10.

The structural features to facilitate attachment of the second exemplary embodiment of the extensible drip irrigation device 110 to the inner surface of the first tube 44 can be the same as discussed above with reference to the first exemplary embodiment of the extensible drip irrigation device 10. Furthermore, in both exemplary embodiments, the drip irrigation devices can be attached to the exterior of the tubing. Further, the drip irrigation devices can be attached to the interior or exterior of a single tube, i.e., tubing not having dual flow paths and not attached along its length to an adjacent tubing.

While specific embodiments and applications are described herein, numerous modifications and variations could be made thereto by those skilled in the art without departing from the scope set forth in the claims.

1-19. (canceled)

20. A spray emitter suitable for use in drip irrigation tubing, the spray emitter comprising:
a housing with an inlet and an outlet; and
a deflector disposed for outwardly deflecting fluid received from the outlet in a spray pattern, the deflector being extensible from a first position to a second position further spaced from the outlet when pressurized with fluid and configured to remain in the second position when no longer pressurized with fluid.

21. The spray emitter of claim 20, wherein a stop is provided for limiting movement of the deflector beyond the second position.

22. The spray emitter of claim 21, wherein the stop is formed between a peripheral portion of the deflector and one of a protuberance and groove of the housing.

23. The spray emitter of claim 21, wherein the stop is formed between a depending skirt of the deflector and one of a protuberance and groove of the housing.

24. The spray emitter of claim 20, wherein a stop is provided to limit movement of the deflector from the second position to the first position, the stop being formed between the deflector and a groove of the housing.

25. The spray emitter of claim 20, wherein the housing includes a bottom wall with an upstanding sidewall, the inlet and the outlet extending through the bottom wall.

26. The spray emitter of claim 20, wherein a nozzle is disposed between the inlet and the outlet.

27. The spray emitter of claim 20, in combination with drip tubing.

28. The spray emitter of claim 27, wherein the spray emitter is attached to the interior of the drip tubing and is in fluid communication therewith for discharging fluid from the drip tubing in a spray pattern through an opening in the tubing aligned with the deflector.

29. The spray emitter of claim 28, wherein the deflector does not protrude through the opening when pressurized.

30. The spray emitter of claim 27, wherein the drip tubing has a pair of independent flow paths.

31. The spray emitter of claim 27, wherein the spray emitter is attached to the exterior of the drip tubing and is in fluid communication therewith for discharging fluid from the drip tubing in a spray pattern.
